(19) United States
(12) Patent Application Publication
(10) Pub. No.: US 2009/0189885 A1
(43) Pub. Date: Jul. 30, 2009

(54) PLASMA DISPLAY PANEL AND METHOD AND DEVICE FOR DRIVING THE SAME

(75) Inventor: Jae-Young YEO, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/351,269

(22) Filed: Jan. 9, 2009

(30) Foreign Application Priority Data
Jan. 24, 2008 (KR) 2008-7592

(51) Int. Cl. G09G 5/00; G09G 3/28

(52) U.S. Cl. 345/214; 345/60

(57) ABSTRACT

In a plasma display panel, errors in a digital image signal due to over-current are prevented from being generated. A method of driving the plasma display panel is performed in a plasma display panel driving block constituted by a high power element and a low power element and includes determining the start point of high current generation in the high power element; stopping the signal transmission of the low power element; determining the end point of the high current generation in the high power element; and resuming the signal transmission of the low power element.

### CROSS-REFERENCE TO RELATED APPLICATION

This application claims priority to and the benefit of Korean Patent Application No. 2008-7592, filed on Jan. 24, 2008, in the Korean Intellectual Property Office, the disclosure of which is incorporated herein by reference.

### BACKGROUND OF THE INVENTION

1. Field of the Invention

Aspects of the present invention relate to a plasma display panel, and particularly to a plasma display panel and a method and a device to drive the same capable of preventing errors from being generated in a digital image signal due to an overcurrent.

2. Description of the Related Art

A plasma display panel (PDP) displays an image from light emitted by phosphors excited by ultraviolet energy generated when an inert mixing gas such as He+Xe, Ne+Xe, He+Xe+Ne, etc., is discharged. PDPs are advantageous as display devices because it is easy to make the panels thin and large. Moreover, the picture quality of PDPs has improved owing to technological developments.

Generally, since it is difficult for a plasma display panel to display an intermediate grayscale level between discharge and non-discharge, the intermediate grayscale level is obtained by using a sub-field system or the like. The sub-field system divides a time interval of one field into a plurality of sub-fields, assigns specific emission weights to the sub-fields, and controls the discharge and non-discharge of each of the sub-fields, thereby displaying a grayscale level of the brightness of one field.

Each sub-field may be made up of a reset section to initialize the state of discharge cells, an address section to select the discharge cells to turn-on/off, and a sustain section to determine the discharge amount. These sections may be controlled by a digital control signal generated by a logic controller, etc.

However, since the control circuit of a plasma display panel includes an analog circuit that generates a driving signal, various switches and a digital circuit for the timing control for the driving signal and data transmission, the control circuit may become somewhat complicated. In addition, the control circuit of the plasma display panel is normally fabricated by disposing elements that differ greatly in their power consumption amount together on several boards for convenience of fabrication or management.

The plasma display panel as described above is driven by applying a high voltage of several hundred volts to the electrode of the panel, and the analog driving circuit applying the driving signal consumes a very large amount of power. An element having a high power consumption, such as, for example the analog driving circuit, can generate a shock wave to peripheral circuits due to instantaneous high power consumption at a peak point in time of a signal to be generated. The generated shock wave can cause an element having a low power consumption, such as, for example, an element of the digital circuit, to generate an operational error.

Operational errors of the digital element caused by shock waves may become a serious problem in an address electrode driving module applying an image signal to be displayed to the address electrode of the plasma display panel.

FIG. 1 is a waveform diagram illustrating the problem in a plasma display device.

According to FIG. 1, an address electrode driving module receives data (“DATA”) to be displayed, together with a synchronous clock signal (“CLK”), from a logic controller of the plasma display panel. However, in the state where data to be displayed is continuously input, if data pulses are applied to a plurality of address electrodes, an instantaneous high power consumption according to the application of the data pulses (as shown, for example, in the region of the “Va CURRENT” labeled “DISCHARGE CURRENT(ON)” of FIG. 1) can generate errors in the receiving of the data. That is, as shown in the lower part of FIG. 1, which is an enlarged representation of the DATA input corresponding to the time frame of generating of the DISCHARGE CURRENT(ON) current, the data input during the generating period of the discharge current, which is an instantaneous large current, is weaker. If the high level of each of the data signals is lower than a reference value of the high level recognized in a recognition circuit, a data error can be generated. The data error may cause a dot-type bad pixel on a screen displayed by the plasma display panel.

### SUMMARY OF THE INVENTION

Aspects of the present invention provide a method and a device of driving a plasma display panel prevent errors in digital signal transmission due to an instantaneous power consumption.

Aspects of the present invention further provide a method and a device of driving a plasma display panel capable to prevent malfunction due to the instantaneous power consumption, while minimizing the structural modification of a control board.

Aspects of the present invention further provide a plasma display device using the method of driving the plasma display panel as described above.

According to an embodiment of the present invention, a method of driving a plasma display panel is performed in a display panel driving block comprising a high power element and a low power element, the method including determining the start point of high current generation in the high power element; stopping the signal transmission of the low power element; determining the end point of the high current generation in the high power element; and resuming the signal transmission of the low power element.

According to an aspect of the present invention, the plasma display panel driving block includes an address electrode driving module to drive the address electrode of the plasma display panel receiving data to be displayed.

According to another aspect of the present invention, the high power element is a data pulse generating circuit that outputs a data pulse to the address electrode, and the low power element is an address buffer that buffers data to be outputted to the address electrode.

According to another aspect of the present invention, the method of driving the plasma display panel is performed in a logic controller for the plasma display panel, and the low power element operates to transmit data from the logic controller to the address buffer.

According to an aspect of the present invention, in the determining of the start point of high current generation in the high power element, the logic controller performs time counting from when a turn-on signal for a switch that resets the scan electrode to a reference voltage in the address section has been generated for a predetermined period of time, to determine the start point of the high current generation.

According to an aspect of the present invention, in the stopping the signal transmission of the low power element, the logic controller stops the transmission of the data and the transmission of a synchronous clock signal applied to the address buffer.

According to an aspect of the present invention, in determining the end point of the high current generation in the high power element, the logic controller performs time counting from the start point of the high current generation for a predetermined period of time to determine the end point of the high current generation.

According to an aspect of the present invention, a logic controller performing the method of driving the plasma display panel according to the present invention is a logic controller that controls a driving signal of a plasma display panel including a scan electrode, a sustain electrode, and an address electrode for each of discharge cells, and includes a scan controlling unit that controls a scan electrode driving module generating a driving signal for the scan electrode; an address controlling unit that transmits display data according to received image data to an address electrode driving module generating a driving signal for the address electrode; and a time counter that counts a period of time that passes from the start point of high current generation in the address electrode driving module.

According to an aspect of the present invention, the address controlling unit stops the transmission of the display data when a predetermined period of time has passed from the starting point of the high current generation. When stopping the transmission of the display data, the address controlling unit also stops the transmission of a synchronous clock signal for the address electrode driving module.

According to an aspect of the present invention, the time counter performs time counting from when a turn-on signal for a switch for that provides a reference voltage to the scan electrode in the address section has been generated, to determine the start point of the high current generation. According to an aspect of the present invention, the time counter includes a first counter that performs time counting from when a turn-on signal for a switch that provides a reference voltage to the scan electrode t in the address section has been generated; and a second counter that performs time counting from the start point of the high current generation.

According to an embodiment of the present invention, a plasma display device having the logic controller includes: a plasma display panel; and a panel driving block having a high power element and a low power element for driving the electrode of the plasma display panel, wherein the panel driving block judges the start point and the end point of high current generation in the high power element to stop the signal transmission of the low power element between the start point and the end point.

According to an aspect of the present invention, the plasma display panel is an alternating current three electrode emissive type plasma display panel having a scan electrode, a sustain electrode, and an address electrode.

According to an aspect of the present invention, the panel driving block includes a logic controller that controls the driving of the plasma display panel; a scan electrode driving module that generates a driving signal for the scan electrode; a sustain electrode driving module that generates a driving signal for the sustain electrode; and an address electrode driving module that generates a driving signal for the address electrode.

According to an aspect of the present invention, the address electrode driving module includes a data pulse generator that outputs a data pulse to the address electrode; and an address buffer that buffers data received and displayed from the logic controller.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of embodiments, taken in conjunction with accompanying drawings of which:

FIG. 1 is a waveform diagram illustrating a problem that occurs in an address electrode driving module when data transmission occurs in proximity to a high current.

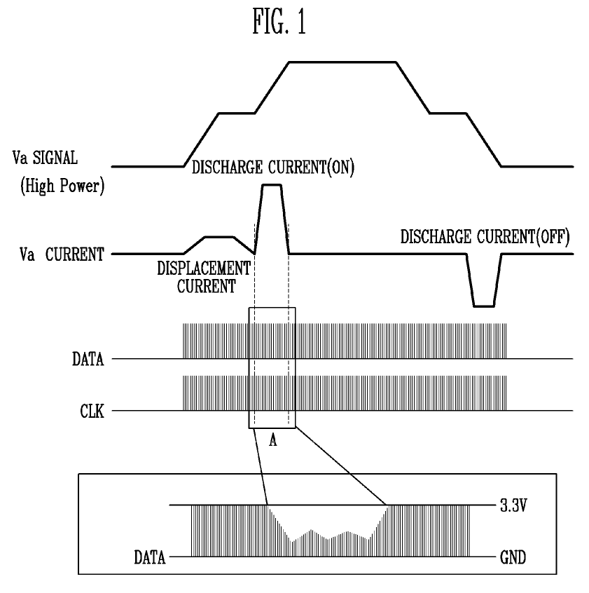

FIG. 2 is a structural view showing the configuration of an electrode line of a three-electrode alternating current discharge type plasma display panel.

FIG. 3 is a diagram illustrating a manner of driving a sub-field of a plasma display panel.

FIG. 4 is a waveform diagram showing driving signals applied to three electrodes of a plasma display panel during one sub-field.

FIG. 5 is a schematic diagram showing a rear surface of a plasma display device according to an embodiment of the present invention.

FIG. 6 is a block diagram showing a structure of an address electrode driving module of the plasma display device of FIG. 5.

FIG. 7 is a block diagram showing a structure of a logic controller of the plasma display device of FIG. 5.

FIG. 8 is a waveform diagram showing an improved effect in the address electrode driving module according to an application of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

While embodiments of the present invention will be concretized and described with reference to a three electrode alternating current surface discharge type PDP in the below description, it is to be understood that aspects of the present invention can be also applied to any plasma display device that includes an element that instantaneously generates a high current and a digital element that generates a lower power and that is capable of being interfered by the generation of the high current. The terms “high power,” “high current,” “low power,” and “high power” are used as they would be commonly understood in the context of a plasma display device and devices that control the plasma display device. For example, the terms “high current” and “high power” relate to the current and power consumption of devices such as, for example, an analog driving circuit that generate shock waves at peak points in time that may disturb peripheral components located near the circuit. The terms “low current” and “low power” relate to the current and power consumption of devices such as, for example, elements of a digital circuit to store or transmit data.

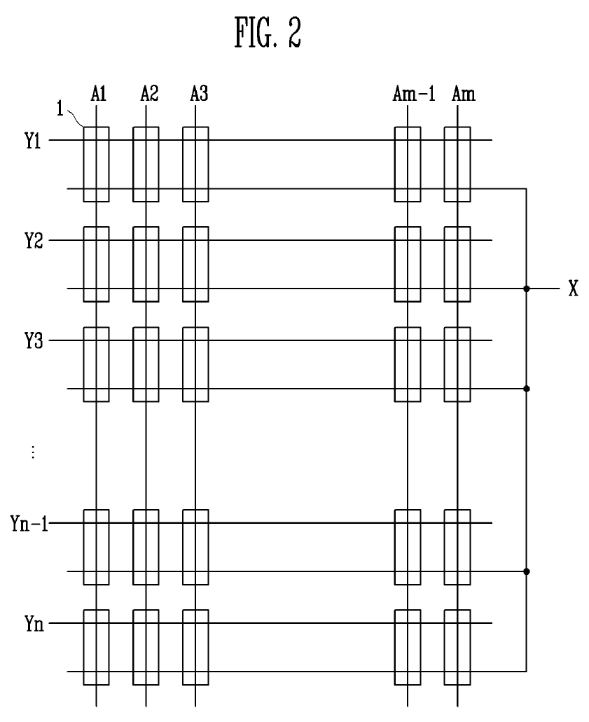

FIG. 2 a structural diagram illustrating the configuration of an electrode line of a three-electrode alternating current discharge type plasma display panel. Referring to FIG. 2, a general three-electrode alternating current surface discharge type PDP includes a plurality of scan electrodes Y1 to Yn, a plurality of sustain electrodes X, and address electrodes Al to Am intersecting with the scan electrodes and the sustain electrodes. Discharge cells 1 that display any one of red, green and blue are formed at the intersecting portion of the scan electrodes Y1 to Yn, the sustain electrodes X, and the address electrodes A1 to Am.

Although not shown in FIG. 2, the scan electrode Y1 to Yn and the sustain electrode X are formed on an upper substrate. A dielectric layer and a passivation layer made of a protective material such as MgO are formed on the upper substrate. The address electrodes A1 to Am are formed on a lower substrate. A barrier rib to prevent optical and electrical interferences between horizontally adjacent cells is formed on the lower substrate. Phosphors excited by ultraviolet energy to discharge visible light are formed on the surfaces of the lower substrate and the barrier rib. An inert mixing gas such as He+Xe, Ne+Xe, He+Xe+Ne, etc., is injected into the discharge space between the upper substrate and the lower substrate.

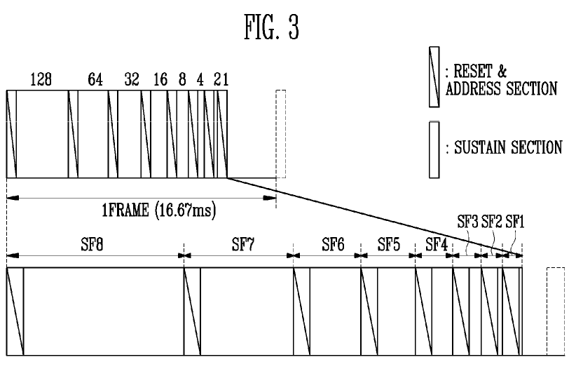

The PDP may be time-division driven by dividing a single frame into several sub-fields having different light emission time period, in order to display the gray scale of an image. For example, if one intends to display an image at 256 gray scale, a frame period (16.67 ms) corresponding to 1/60^{th} of a second is divided into eight sub-fields SF1 to SF8, as shown in FIG. 3. Each of the eight sub-fields SF1 to SF8 is divided into a reset section, in which the discharge cell 1 is initialized, an address section, in which a scan electrode line and a discharge cell in the selected scan electrode line are selected, and a sustain section to represent the gray scale according the discharge time periods and to maintain the discharge of the selected discharge cell. While the reset sections and the address sections of the respective sub-fields are the same per the respective sub-fields, the time length of the sustain sections and the sustain pulses assigned to them are increased in the ratio of 2ⁿ(n=0,1,2,3,4,5,6,7) in the respective sub-fields.

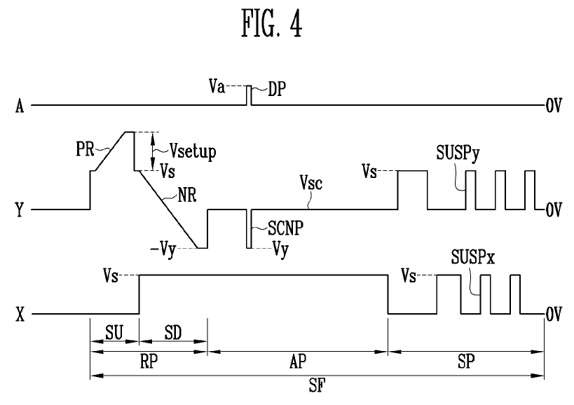

FIG. 4 illustrates waveforms of an address driving signal, a scan driving signal, and a sustain driving signal supplied to the three electrodes A, Y, X, respectively, of the plasma display panel in one sub-field (SF) of a plurality of sub-fields. The driving signals are divided into a reset section RP to initialize the discharge cells of the full screen, an address section AP to select the discharge cell, and a sustain section SP to maintain the discharge of the selected discharge cell.

In the reset section RP, a rising ramp waveform PR, which rises at a predetermined slope from sustain voltage Vs to first peak voltage Vs+Vsetup and a falling ramp waveform NR, which falls at a predetermined slope from the sustain voltage Vs to a second peak voltage −Vy, are applied to all of the scan electrodes Y.

In the address section AP, a negative (−) address section pulse SCNP is sequentially applied to the scan electrodes Y and at the same time, a positive (+) data pulse DP is applied to the address electrodes A. The voltage difference between the address section pulse SCNP and the data pulse DP and wall voltage created in the reset section RP are added so that an address discharge is generated within the cell to which the data pulse DP is applied. Wall charges are created within the selected cells by such an address discharge.

Meanwhile, a positive (+) sustain discharge voltage Vs is maintained in the sustain electrodes X during a set-down period SD in the reset section PR and the address section AP.

In the sustain section SP, sustain pulses SUSPy and SUSPx are alternatively applied to the scan electrodes Y and the sustain electrodes X. In the selected cell, by the address discharge, a the wall voltage within the cell and the voltage of the sustain pulses SUSPy and SUSPx are added so that whenever each of the sustain pulses SUSPy and SUSPx is applied, the sustain discharge is generated in the form of a surface discharge between the scan electrode Y and the sustain electrode X. The sustain pulses SUSPy and SUSPx have the level of the sustain voltage.

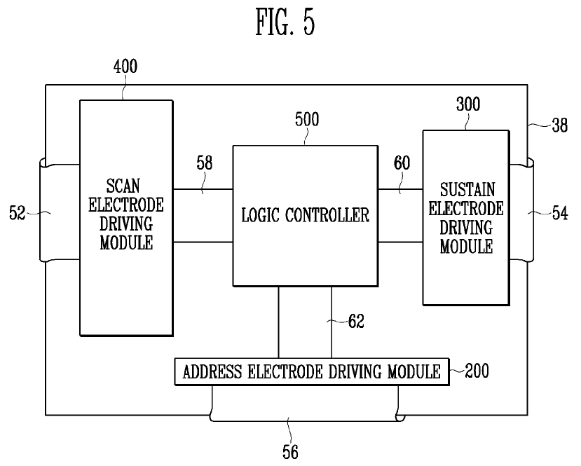

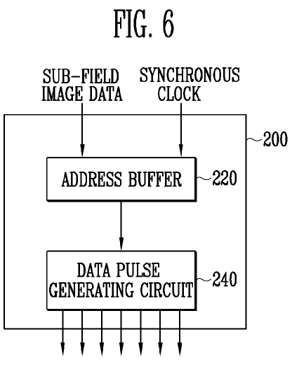

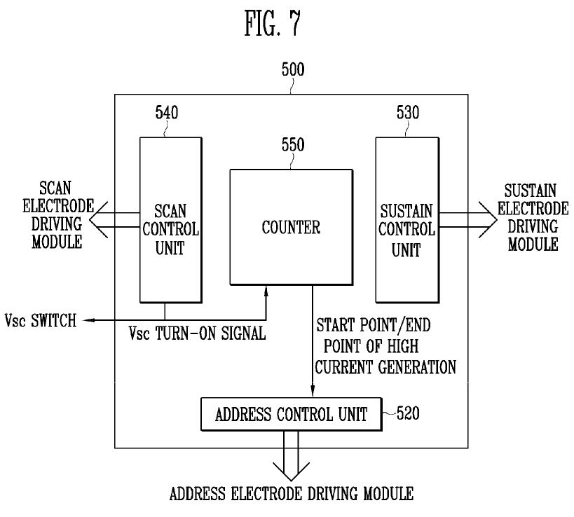

FIG. 5 shows a control circuit block formed on a rear surface of a plasma display device according to an embodiment of the present invention, FIG. 6 shows a structure of an address driving module constituting the control circuit block of FIG. 5, and FIG. 7 shows a structure of a logic controller constituting the control circuit block of FIG. 5.

Referring to FIG. 5, the plasma display device includes a scan electrode driving module 400, a sustain electrode driving module 300, an address electrode driving module 200, and a logic controller 500 each dispersed and installed as a panel driving block on the rear surface of a plasmas display panel (PDP) 38 that displays an image.

The PDP 38 has a structure that the upper substrate and the lower substrate thereof are bonded to provide a gas discharge space. Scan electrode lines and sustain electrode lines are formed in parallel on the upper surface, and address electrode lines are formed to intersect with the electrode lines of the upper substrate on the lower substrate. Y pads (not shown) coupled to the scan electrode lines and X pads (not shown) coupled to the sustain electrode lines may be formed on the upper substrate. Pads (not shown) coupled to the address electrode lines may be formed on the lower substrate.

The scan electrode driving module 400 may include a scan driver board that generates the reset waveforms PR and NR and the address section pulse SCNP of FIG. 4, and a Y sustainer board that generates the sustain voltage Vs and the Y sustain pulse SUSPy. The scan electrode driving module 400 supplies the reset waveforms PR and NR, the address section pulse SCNP, the sustain voltage Vs, and the Y sustain pulse SUSPy via a Y conducting path 52 to the scan electrodes of the PDP 38.

To this end, the scan driver board may include a scan driver integrated circuit (IC) that generates the reset waveforms PR and NR and the address section pulse SCNP. The Y sustainer board may include a Y sustain circuit that generates the sustain voltage Vs and the Y sustain pulse SUSPy.

The sustain electrode driving module 300 generates the sustain voltage Vs and the X sustain pulse SUSPx shown in FIG. 4, and supplies the Vs and SUSPx via an X conducting path 54 to the common sustain electrodes X of the PDP 38. To this end, the sustain electrode driving module 300 may include an X sustain circuit that generates the sustain voltage Vs and the X sustain pulse SUSPx.

The address electrode driving module 200 generates the data pulse DP shown in FIG. 4, and supplies the DP via an A conducting path 56 to the address electrodes.

The logic controller 500 generates control signals to control the timing of each transition of an address electrode driving signal, a sustain electrode driving signal, and a reset electrode driving signal.

The logic controller 500 supplies a Y timing control signal via a first conducting path 58 to the scan electrode driving module 400, supplies an X timing control signal via a second conducting path 60 to the sustain electrode driving module 300, and an A timing control signal via a third conducting path 62 to the address electrode driving module 200. That is, the logic controller 500 controls the operations of the sustain electrode driving module 300, the scan electrode driving module 400, and the address electrode driving module 200 using the X, Y, and A timing control signals.

As the respective conducting paths 52, 54, 56, 58, 60, and 62, any suitable conductor such as, for example, a flexible flat cable, a flexible printed cable, or the like may be used.

The term “logic controller 500” as used herein basically refers to a logic controller module coupled to peripheral other elements to assist the PDP driving control operation. However, in the present embodiment, a term “logic controller” may refer to the logic controller module itself as well as to a PDP driving device coupled to peripheral respective driving modules.

The address driving module 200 may be implemented as a structure as shown in FIG. 6. In particular, the address driving module 200 may include a data pulse generating circuit 240 that outputs data pulses to the address electrode of the plasma display panel, and a buffer 220 that buffers data received and displayed from the logic controller of the plasma display panel.

The data input from the logic controller to the address buffer 220 are image data to be displayed. When using a frame divided into sub-fields as shown in FIG. 3, the image data are the values indicating an on/off mode of the pixel in each of the sub-fields, and are digital values transmitted through one transmitting line or several transmitting lines. The image data are temporally stored in the address buffer 220.

The data pulse generating circuit 240 may include a driver IC that switches the driving signals applied to the respective electrodes of the plasma display panel, and an analog driving circuit to supply a high voltage necessary for the driving signal.

The analog driving circuit adds the data pulse to a corresponding electrode driving signal only for the address electrode recorded in the address buffer 220. At this time, since the data pulses are simultaneously applied to a plurality of address electrodes, the analog driving circuit consumes a considerable amount of power when the data pulses are applied.

According to aspects of the present invention, the logic controller 500 determines the high current generation time due to the high power consumption in the analog driving circuit and stops the data transmission during the high current generation time. At the same time, a clock for data transmission synchronization between the address buffer 220 and the logic controller is also stopped, so that a mutual synchronization error due to the data transmission stoppage during the high current generation time may be prevented without a separate additional measure.

FIG. 7 shows an embodiment of the logic controller of the plasma display device of FIG. 5.

The logic controller 500 shown in FIG. 7 controls the driving signal of a three electrode alternating current surface discharge type plasma display panel having a scan electrode, a sustain electrode, and an address electrode for each of a plurality of discharge cells. The logic controller 500 includes a scan control unit 540 that controls a scan electrode driving module that generates a driving signal for the scan electrode, a sustain control unit 530 that controls a sustain electrode driving module that generates a driving signal for the sustain electrode, an address control unit 520 that transmits received image data to an address electrode driving module that generates a driving signal for the address electrode, and a counter 550 that counts time that has passed from the start point of high current generation of the address electrode driving module.

The address control unit 520 stops the transmission of the data to be displayed from the start point of the high current generation until a predetermined time has passed from the start point of the high current generation. At the same time, the address control unit 520 also stops the transmission of a synchronous clock for the address buffer within the address electrode driving module, thereby preventing asynchronization due to the data transmission stoppage without a separate additional measure. Herein, the term “stopping” of the data and/or the synchronous clock refers to maintaining a high state or a low state during the stop time, rather than floating the data transmission line and/or the clock transmission line.

As a method to determine the start point of the high current generation of the address electrode driving module, several schemes may be used.

According to one scheme, the counter 550 performs time counting from when a turn-on signal for a scan position has been generated in the scan control unit 540 in order to judge when a predetermined time has passed as the start point of the high current generation. Herein, the scan position is provided in the scan electrode driving module and indicates a switch coupling the scan electrode to a scan voltage Vsc terminal in order to make the scan electrode the reference voltage in the address section.

The address electrode driving signal, the scan electrode driving signal, and the sustain electrode driving signal may be applied to corresponding electrodes in mutually synchronous state. Therefore, the sustain control unit 530, the scan control unit 540, and the address control unit 520 of the logic controller 500 are mutually synchronous to output the control signals for corresponding modules.

As can be appreciated from FIGS. 3 to 8, particularly, FIG. 4, the section in which the data pulses for the address electrode are generated is the address section, wherein it is observed that an obvious transition to the scan electrode driving signal is generated during a changeover from the reset section to the address section. The transition is transition from the lowest voltage −Vy in the reset section to the initial voltage Vsc (also referred to as the scan voltage) in the address section. Generally, the transition is performed by the turn-on of a scan switch coupling the scan electrode to the scan voltage Vsc terminal.

Therefore, when the address section starts, the scan control unit 540 of the logic controller 500 outputs a turn-on control signal for the scan switch, and can judge the start point of the address section therefrom.

The address electrode driving module 200 generates the data pulse when a predetermined period time has passed after the address section starts. Therefore, the address control unit 520 of the logic controller 500 can judge that the high current is being generated in the address electrode driving module 200 when a predetermined period of time has passed after the turn-on control signal for the scan switch is output.

To this end, the counter 550 of FIG. 7 can include a first counter that performs time counting from when the scan control unit has generated the turn-on signal for the scan switch, and a second counter that performs time counting from the start point in time of the address section or the start point of the high current generation.

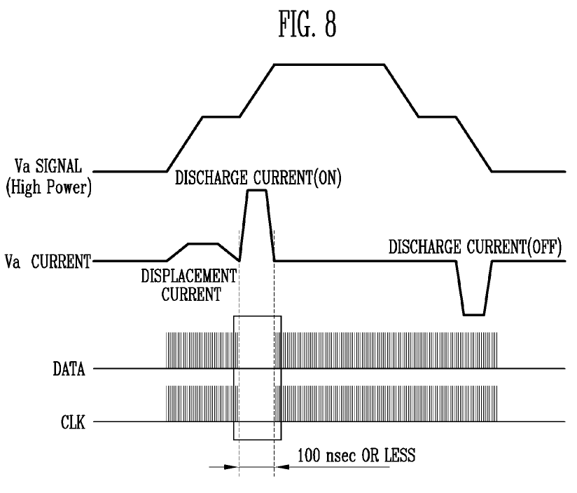

As shown in FIG. 8, when the synchronous clock is transmitted together with data from the logic controller to the address buffer, both the transmitting of the synchronous clock and the transmitting of the data are stopped together, thereby making it possible to prevent a timing error due to the stopping of the data transmission.

Types of high current capable of having an effect on the address buffer in FIG. 8 include a displacement current, an ON discharge current, and an OFF discharge current. Among these, the ON discharge current has the highest possibility of providing an error to the data input of the address buffer, and therefore, it is desirable to stop the data transmission during the generation period of the ON discharge current. In order to stop the data transmission only during the generation period of the ON discharge current, the data transmission may be stopped for a period of 80 to 160 nsec, or more specifically, for a period of about 90 nsec to 110 nsec from the start point of the high current generation. The high current generation period for the ON discharge current is typically 90 nsec to 110 nsec from the point in time when the turn-on signal of the scan switch is actuated.

Meanwhile, if the synchronous clock is not transmitted together with the data from the logic controller to the address buffer but rather, is separately received in the address buffer, a separate stop signal is applied to the terminal that stops the driver IC to control the synchronous clock signal, thereby preventing the timing error.

If the plasma display device according to aspects of the present invention described above is implemented, it is possible to prevent errors from being generated in the image signal due to instantaneous power consumption.

Also, aspects of the present invention can prevent malfunction due to the instantaneous power consumption, while minimizing the structure modification of a conventional control board.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of driving a plasma display panel which is performed in a plasma display panel driving block comprising a high power element and a low power element, the method comprising:
determining a start point of high current generation in the high power element;
stopping a signal transmission of the low power element;
determining an end point of the high current generation in the high power element; and
resuming the signal transmission of the low power element.

2. The method of driving the plasma display panel as claimed in claim 1, wherein the plasma display panel driving block comprises an address electrode driving module to drive an address electrode of the plasma display panel to receive data to be displayed.

3. The method of driving the plasma display panel as claimed in claim 2, wherein the high power element is a data pulse generating circuit that outputs a data pulse to the address electrode.

4. The method of driving the plasma display panel as claimed in claim 2, wherein the low power element is an address buffer that buffers data to be output to the address electrode.

5. The method of driving the plasma display panel as claimed in claim 4, wherein the plasma display panel driving block further comprises a logic controller that controls the determining of the start point of high current generation in the high power element; the stopping of the signal transmission of the low power element; the determining of the end point of the high current generation in the high power element; and the resuming of the signal transmission of the low power element.

6. The method of driving the plasma display panel as claimed in claim 5, wherein the low power element operates to transmit data from the logic controller to the address buffer.

7. The method of driving the plasma display panel as claimed in claim 6, wherein in the stopping of the signal transmission of the low power element, the transmission of the data and a transmission of a synchronous clock signal applied from the logic controller to the address buffer are stopped.

8. The method of driving the plasma display panel as claimed in claim 6, wherein the plasma display panel is a three-electrode alternating current discharge type plasma display panel driven by a reset section, an address section, and a sustain section and having a scan electrode, a sustain electrode, and the address electrode.

9. The method of driving the plasma display panel as claimed in claim 8, wherein in the determining of the start point of high current generation in the high power element, the logic controller performs time counting from when a turn-on signal for a switch that resets the scan electrode to a reference voltage in the address section has been generated for a first predetermined time to determine the start point of the high current generation.

10. The method of driving the plasma display panel as claimed in claim 9, wherein in the determining of the end point of the high current generation in the high power element, the logic controller performs time counting from the start point of the high current generation for a second predetermined period of time to determine the end point of the high current generation.

11. The method of claim 10, wherein the second predetermined period of time is 80 to 160 nanoseconds.

12. The method of claim 10, wherein the second predetermined period of time is 90 to 110 nanoseconds.

13. A device to drive a plasma display panel having a scan electrode, a sustain electrode and an address electrode for each of a plurality of discharge cells and to control a driving signal of the plasma display panel, the device comprising:
a scan control unit that controls a scan electrode driving module to generate a driving signal for the scan electrode;
an address control unit that transmits display data according to received image data to an address electrode driving module to generate a driving signal for the address electrode; and
a time counter that counts a period of time that passes from a starting point of high current generation of the address electrode driving module.

14. The device of claim 13, wherein the address control unit stops the transmission of the display data for a predetermined period of time after the starting point of the high current generation.

15. The device of claim 14, wherein the predetermined period of time is 80 to 160 nanoseconds.

16. The device of claim 14, wherein the predetermined period of time is 90 to 110 nanoseconds.

17. The device to drive the plasma display panel as claimed in claim 14, wherein the address control unit also stops a transmission of a synchronous clock signal for the address electrode driving module at the same time that the transmission of the display data is stopped.

18. The device to drive the plasma display panel as claimed in claim 13, wherein the time counter counts a period of time that passes from when a turn-on signal for a switch that resets the scan electrode to a reference voltage in an address section has been generated in the scan control unit, to determine the starting point of the high current generation.

19. The device to drive the plasma display panel as claimed in claim 18, wherein the time counter comprises:
a first counter that performs time counting from when the turn-on signal for the switch that resets the scan electrode to the reference voltage in the address section has been generated; and
a second counter that performs time counting from the starting point of the high current generation.

20. A plasma display device comprising:
a plasma display panel; and
a panel driving block having a high power element and a low power element to drive electrodes of the plasma display panel,
wherein the panel driving block determines a start point and an end point of high current generation in the high power element and stops a signal transmission of the low power element between the start point and the end point.

21. The plasma display device as claimed in claim 20, wherein the plasma display panel is a three-electrode alternating current emissive type plasma display panel having a scan electrode, a sustain electrode, and an address electrode.

22. The plasma display device as claimed in claim 21, wherein the panel driving block comprises:
a logic controller that controls a driving of the plasma display panel;
a scan electrode driving module that generates a driving signal for the scan electrode;
a sustain electrode driving module that generates a driving signal for the sustain electrode; and
an address electrode driving module that generates a driving signal for the address electrode.

23. The plasma display device as claimed in claim 22, wherein the logic controller comprises:
a scan control unit that controls the scan electrode driving module;
a sustain control unit that controls the sustain electrode driving module;
an address control unit that controls the address electrode driving module and transmits display data according to received image data; and
a time counter that counts a period of time that passes from the start point of high current generation of the address electrode driving module, wherein the logic controller determines the end point of high current generation according to a predetermined time period counted by the time counter.

24. The device of claim 23, wherein the predetermined period of time is 80 to 160 nanoseconds.

25. The device of claim 23, wherein the predetermined period of time is 90 to 110 nanoseconds.

26. The plasma display device as claimed in claim 23, wherein the address control unit stops the transmission of the display data between the start point and the end point of the high current generation.

27. The plasma display device as claimed in claim 26, wherein the address control unit also stops a transmission of a synchronous clock signal of the address electrode driving module when the transmission of the display data is stopped.

28. The plasma display device as claimed in claim 27, wherein the time counter also performs time counting from when a turn-on signal for a switch that resets the scan electrode to a reference voltage in the address section has been generated in the scan control unit, to determine the start point of the high current generation.

29. The plasma display device as claimed in claim 28, wherein the address electrode driving module comprises:
a data pulse generator that outputs a data pulse to the address electrode; and
an address buffer that buffers data received and displayed from the logic controller.

30. A method of driving a plasma display panel having a scan electrode, a sustain electrode and an address electrode, the method comprising;
transmitting display data and a synchronous clock signal to an address electrode driving module;
transmitting a turn-on signal for a switch that resets the scan electrode to a reference voltage;
determining when a first predetermined period of time has passed from the transmitting of the turn-on signal;
stopping the transmitting of the display data and the synchronous clock signal after the first predetermined period of time has passed;
determining when a second predetermined period of time has passed from the stopping of the transmitting of the display data and the synchronous clock signal; and
resuming the transmitting of the display data and the synchronous clock signal after the second predetermined period of time has passed,
wherein the first predetermined period of time and the second predetermined period of time are selected such that the stopping of the transmitting of the display data and the synchronous clock signal occurs during a period of high current generation of the address electrode driving module.
